(19) United States
(12) Patent Application Publication
(10) Pub. No.: US 2014/0325023 A1
(43) Pub. Date: Oct. 30, 2014

(54) SIZE PREDICTION IN STREAMING ENVIROMENTS

(71) Applicant: CISCO TECHNOLOGY, INC., San Jose, CA (US)

(72) Inventors: Matthew Francis Caulfield, Clinton, MA (US); Eric Colin Friedrich, Somerville, MA (US); Carol Etta Iturralde, Framingham, MA (US); Mahesh Vittal Viveganandhan, Cupertino, CA (US); Scott C. Labrozzi, Cary, NC (US)

(73) Assignee: CISCO TECHNOLOGY, INC., San Jose, CA (US)

(21) Appl. No.: 13/869,811

(22) Filed: Apr. 24, 2013

(51) Int. Cl. H04L 29/06

(52) U.S. Cl. CPC H04L 65/608
USPC 709/219

(57) ABSTRACT

A method is provided in one example embodiment and includes receiving a request for video content from a client device and accessing a common format representation for a requested chunk within the video content. The common format representation is provided in one or more files that include metadata indicative of one or more counters. The method can also include using the common format representation in conjunction with a deterministic equation to identify a predicted size of an output to be sent to the client device; and using the predicted size of the output to initiate transmitting at least a portion of a response to the client.

### TECHNICAL FIELD

This disclosure relates in general to the field of communications and, more particularly, to a system, an apparatus, and a method for providing size prediction in streaming environments.

### BACKGROUND

End users have more media and communications choices than ever before. A number of prominent technological trends are currently afoot (e.g., more computing devices, more online video services, more Internet video traffic), and these trends are changing the media delivery landscape. Separately, these trends are pushing the limits of capacity and, further, degrading the performance of video, where such degradation creates frustration amongst end users, content providers, and service providers. In many instances, the video data sought for delivery is dropped, fragmented, delayed, or simply unavailable to certain end users.

Adaptive Streaming is a technique used in streaming multimedia over computer networks. While in the past, most video streaming technologies used either file download, progressive download, or custom streaming protocols, most of today's adaptive streaming technologies are based on hypertext transfer protocol (HTTP). These technologies are designed to work efficiently over large distributed HTTP networks such as the Internet.

HTTP-based Adaptive Streaming (HAS) operates by tracking a user's bandwidth and CPU capacity, and then selecting an appropriate representation (e.g., bandwidth and resolution) among the available options to stream. Typically, HAS would leverage the use of an encoder that can encode a single source video at multiple bitrates and resolutions (e.g., representations), which can be representative of either constant bitrate encoding (CBR) or variable bitrate encoding (VBR). The player client can switch among the different encodings depending on available resources. Ideally, the result of these activities is little buffering, fast start times, and good video quality experiences for both high-bandwidth and low-bandwidth connections.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of a communication system for providing encapsulation size prediction in adaptive streaming environments in accordance with one embodiment of the present disclosure;

FIG. 1B is a simplified schematic diagram illustrating a common format conversion example associated with the present disclosure;

FIG. 1C is a simplified block diagram illustrating an example pipeline dataflow associated with the present disclosure;

FIG. 2 is a simplified block diagram illustrating possible example details associated with particular scenarios involving the present disclosure; and

FIGS. 3-4 are simplified flowcharts illustrating potential operations associated with the communication system in accordance with certain embodiments of the present disclosure.

### DETAILED DESCRIPTION OF EXAMPLE EMBODIMENTS

### Overview

A method is provided in one example embodiment and includes receiving a request for video content from a client device, and accessing a common format representation for a requested chunk within the video content. The common format representation is provided in one or more files that include metadata indicative of one or more counters. The method can also include using the common format representation in conjunction with a deterministic equation to identify a predicted size of an output to be sent to the client device; and using the predicted size of the output to initiate transmitting at least a portion of a response to the client.

### EXAMPLE EMBODIMENTS

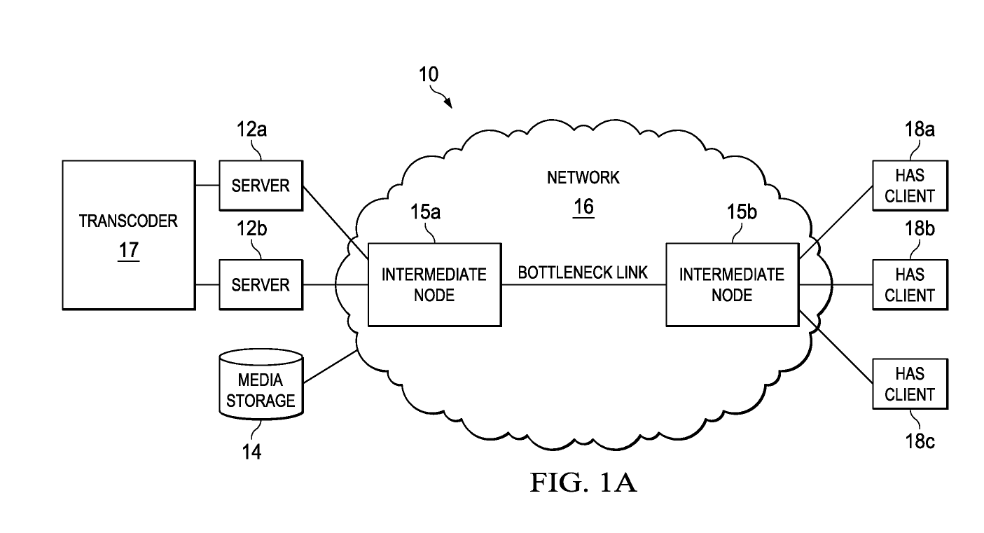

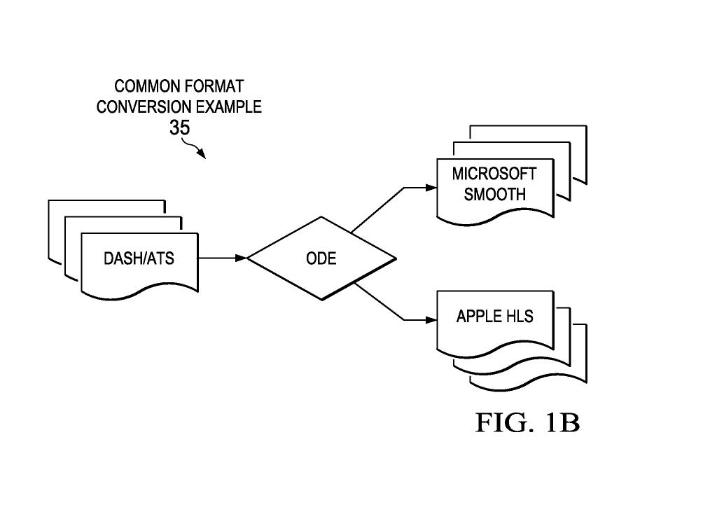

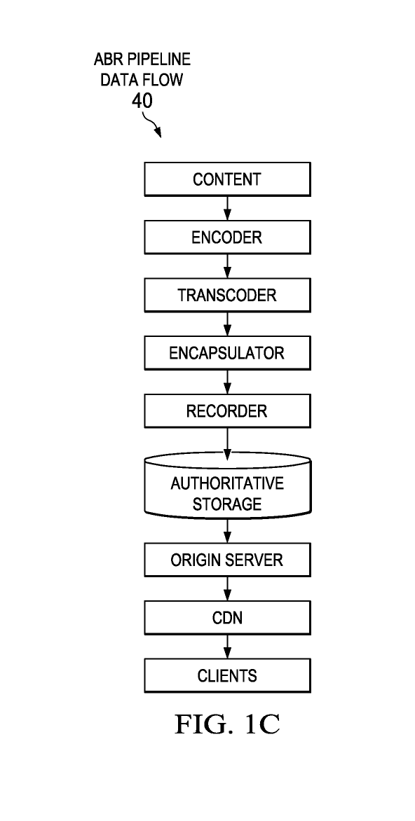

Turning to FIG. 1A, FIG. 1A is a simplified block diagram of a communication system 10 configured for providing encapsulation size prediction, for example, among adaptive bit rate (ABR) flows for a plurality of clients in accordance with one embodiment of the present disclosure. Communication system 10 may include a plurality of servers 12a-b, a media storage 14, a network 16, a transcoder 17, a plurality of hypertext transfer protocol (HTTP)-based Adaptive Streaming (HAS) clients 18a-c, and a plurality of intermediate nodes 15a-b. Note that the originating video source may be a transcoder that takes a single encoded source and “transcodes” it into multiple rates, or it could be a “Primary” encoder that takes an original non-encoded video source and directly produces the multiple rates. Therefore, it should be understood that transcoder 17 is representative of any type of multi-rate encoder, transcoder, etc.

Servers 12a-b are configured to deliver requested content to HAS clients 18a-c. The content may include any suitable information and/or data that can propagate in the network (e.g., video, audio, media, any type of streaming information, etc.). Certain content may be stored in media storage 14, which can be located anywhere in the network. Media storage 14 may be a part of any web server, logically connected to one of servers 12a-b, suitably accessed using network 16, etc. In general, communication system 10 can be configured to provide downloading and streaming capabilities associated with various data services. Communication system 10 can also offer the ability to manage content for mixed-media offerings, which may combine video, audio, games, applications, channels, and programs into digital media bundles.

In accordance with certain techniques of the present disclosure, the architecture of FIG. 1A can provide enhanced metadata that can improve system performance significantly. More specifically, the architecture is configured to include counters in common format metadata, where this allows a particular server (e.g., an origin server) to predict a size of a target format segment before it is translated. Note that these size prediction activities are discussed in considerable detail and with reference to a number of accompanying FIGURES. Example embodiments of the present disclosure can offer a significant reduction in memory requirements on the server. In certain cases, this may come in exchange for a slight increase in the size of the common format metadata (e.g., as when compared to an approach that maintains the entire target format segment in memory before sending it).

Additionally, certain techniques discussed herein can offer considerable utility for ABR applications over a wide range of utilization levels, while requiring only minimal admission control to prevent gross overload of network resources. In addition, teachings of the present disclosure can provide a generic, flexible technique that may be applicable to a wide range of applications within the ABR space. Note that such an encapsulation size prediction paradigm can be deployed regardless of the underlying transport protocol's (e.g., TCP, SCTP, MP-TCP, etc.) behavior. Note also that the mechanism described here may be used in different ways in different applications (such as applications different from the examples given below) to achieve enhanced bandwidth management functions.

Before detailing these activities in more explicit terms, it is important to understand some of the bandwidth challenges encountered in a network that includes HAS clients. The following foundational information may be viewed as a basis from which the present disclosure may be properly explained. Adaptive streaming video systems make use of multi-rate video encoding and an elastic IP transport protocol suite (typically hypertext transfer protocol/transmission control protocol/Internet protocol (HTTP/TCP/IP), but could include other transports such as HTTP/SPDY/IP, etc.) to deliver high-quality streaming video to a multitude of simultaneous users under widely varying network conditions. These systems are typically employed for “over-the-top” video services, which accommodate varying quality of service over network paths.

In adaptive streaming, the source video is encoded such that the same content is available for streaming at a number of different rates (this can be via either multi-rate coding, such as H.264 AVC, or layered coding, such as H.264 SVC). The video can be divided into “chunks” of one or more group-of-pictures (GOP) (e.g., typically two (2) to ten (10) seconds of length). HAS clients can access chunks stored on servers (or produced in near real-time for live streaming) using a web paradigm (e.g., HTTP GET operations over a TCP/IP transport), and they depend on the reliability, congestion control, and flow control features of TCP/IP for data delivery. HAS clients can indirectly observe the performance of the fetch operations by monitoring the delivery rate and/or the fill level of their buffers and, further, either upshift to a higher encoding rate to obtain better quality when bandwidth is available, or downshift in order to avoid buffer underruns and the consequent video stalls when available bandwidth decreases, or stay at the same rate if available bandwidth does not change. Compared to inelastic systems such as classic cable TV or broadcast services, adaptive streaming systems use significantly larger amounts of buffering to absorb the effects of varying bandwidth from the network.

In a typical scenario, HAS clients would fetch content from a network server in segments. Each segment can contain a portion of a program, typically comprising a few seconds of program content. [Note that the term ‘segment’ and ‘chunk’ are used interchangeably in this disclosure.] For each portion of the program, there are different segments available with higher and with lower encoding bitrates: segments at the higher encoding rates require more storage and more transmission bandwidth than the segments at the lower encoding rates. HAS clients adapt to changing network conditions by selecting higher or lower encoding rates for each segment requested, requesting segments from the higher encoding rates when more network bandwidth is available (and/or the client buffer is close to full), and requesting segments from the lower encoding rates when less network bandwidth is available (and/or the client buffer is close to empty).

Turning to FIG. 1B, FIG. 1B is a simplified schematic diagram illustrating a common format version example 35 associated with the present disclosure. A fundamental problem in content delivery is the need to serve a wide variety of client devices. For example, in the context of ABR video, these various client device types each require specific metadata and specific video formats. The following are examples of prevalent ABR client types: Microsoft Smooth (HSS), Apple HTTP Live Streaming (HLS), and Adobe Zeri (HDS). A server that handles requests from a heterogeneous pool of ABR clients should store its content in a form that can be easily translated to the target client format. In a simple implementation, such a server could store a separate copy of a piece of content for each client device type. However, this approach negatively impacts storage and bandwidth usage. In a caching network (CDN), for example, multiple formats of the same piece of content would be treated independently, further exacerbating the problem.

On-demand encapsulation (ODE) attempts to address several issues associated with storage and bandwidth. With ODE, a single common format representation of each piece of content can be stored and cached by the server. Upon receiving a client request, the server can re-encapsulate the common format representation into a client device format. ODE provides a tradeoff between storage and computation. While storing a common format representation incurs lower storage overhead, re-encapsulating that representation on-demand is considerably more expensive (in terms of computation) than storing each end-client representation individually.

A common format should be chosen to meet the needs of all client device types. Moreover, the common format and its associated metadata should be easily translated into either client format (as depicted in the example of FIG. 1B). Adaptive Transport Stream (ATS) is an ABR conditioned moving picture experts group (MPEG)-transport stream (TS) (MPEG2-TS) with in-band metadata for signaling ABR fragment and segment boundaries. Dynamic Adaptive Streaming over HTTP (DASH) is a standard for describing ABR content. The common format specification is fundamental to ODE.

In order to minimize the amount of data stored in memory during, ODE, a system that is translating ‘common format’ to a target format content should begin sending the target format response to the client as soon as the target format data becomes available. This stands in contrast to waiting for an entire segment, or a fragment to be translated.

Sending data before it is available in its entirety may be accomplished via HTTP chunked encoding. Unfortunately, chunk encoded responses would not universally interact favorably with HTTP caches; it can cause inefficiencies in the distribution network. Data may also be sent before it is entirely available if the complete size of the data is known upfront. Due to the nature of ODE, only the size of the common format data is known upfront. The size of the target format data is known once the translation from a common format to a target format is complete. Without a method for predicting the size of a target format segment, the ODE server holds the entire target format segment in memory. Storing entire segments in the process memory reduces the scalability and potential density of servers that implement on-demand encapsulation.

FIG. 1C is a simplified block diagram illustrating an example pipeline dataflow 40 associated with an ABR application. The ABR content workflow may be understood as a pipeline of functional blocks strung together for delivering ABR content to clients. Content can arrive at the system in a raw format. The encoding stage can convert the raw format content into a compressed form at a single high-quality level. The transcoding stage produces multiple lower-quality versions of the content from the single high-quality version. The encapsulation stage typically prepares the content at a quality-level for a specific end-client type (e.g., Smooth, HLS, etc.). The recording stage accepts the set of contents, including formats for multiple clients with multiple quality-levels, and saves them to an authoritative store. At the origination stage (upon receiving a request) serves content based on client type and the requested quality level.

The CDN can cache content in a hierarchy of locations to decrease the load on the origination stage and, further, to improve the quality of experience for the users in the client stage. Finally, the client stage can decode and present the content to the end user. The pipeline can be similar for both Live and video on demand (VoD) content, although in the case of VoD the recording stage may be skipped entirely. For VoD, content can be stored on a Network-Attached Storage (NAS) for example.

Some of the more significant aspects of ODE take place between the encapsulation and origination stages of the pipeline. The encapsulation stage produces the common format media and indexing metadata. The recording stage accepts the common format and writes it to storage. The origination stage reads the common format representation of content and performs the encapsulation when a request is received from a particular client type.

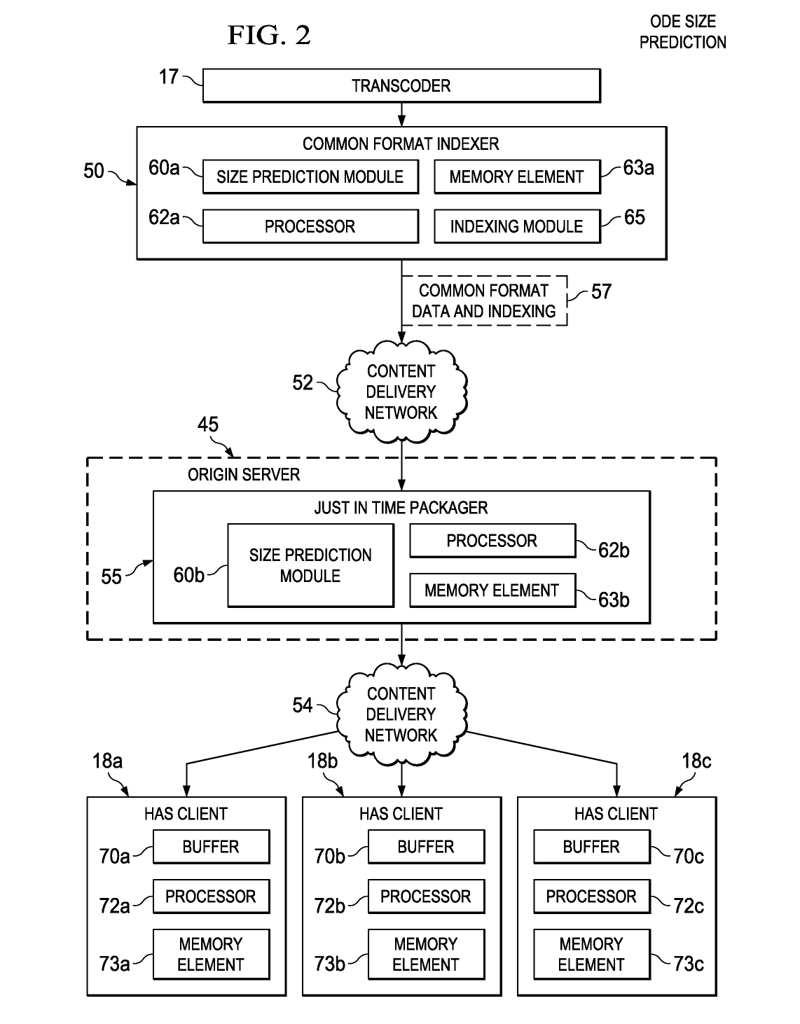

Turning to FIG. 2, FIG. 2 is a simplified block diagram illustrating one possible architecture that may be associated with the present disclosure. FIG. 2 illustrates a common format indexer 50, a CDN 52, a CDN 54, an origin server 45, and a just in time packager 55. Common format indexer 50 and origin server 45 include a respective size prediction module 60a, 60b, a respective processor 62a, 62b, and a respective memory 63a, 63b. Common format indexer may also include an indexing module 65. In addition, a hatched box 57 is also provided, as it illustrates a common format data and indexing segment that propagates toward the network. Additionally, each of HAS clients 18a-c include a respective buffer 70a-70c, a respective processor 72a-c, and a respective memory 71a-c.

In operation of a generalized example, when common format data is created (e.g., when a common format manifest file is generated (that describes the format)), the system can position one or more counters in the metadata itself. For example, a certain piece of common format data can have a designated number of audio transport stream (TS) packets (e.g., for MPEG-TS packets), a designated number of video TS packets, a certain amount of raw audio data, a certain amount of raw video data, etc. This information can be suitably listed in a file for subsequent access/reference (for example, in the context of receiving a request for certain content from a client). This access would allow the numbers to be read first, beforehand, where an estimation could then be made concerning its corresponding size. Subsequently, the actual data would be read.

Once the counters are made available, a simple weighting could be used in order to approximate the corresponding size associated with a particular video segment. This would allow buffer settings to occur at, for example, an origin server. Hence, a buffer could be sized based on this information. This information can also be used to set a content length header value, where the translation would subsequently ensue.

Such an approach would allow for a lower memory requirement on the origin server because the system can begin transmitting pieces of the response (to the client) without building up the entire requested content. Without implementing the teachings of the present disclosure, the entire response (e.g., the entire Microsoft Smooth video fragment) would have to be built before being sent to the client because the system should know the content length header requirement. Hence, the entire translation would have to occur before anything is sent to the client. All of this information would have to be allocated to memory before anything is transmitted for the client. In contrast to those activities, by using the counter/indexing features of the present disclosure, the response can be sent in pieces and, thereby, it can minimize the strain placed on the working memory at the origin server. This also reduces the burstiness issues (that would otherwise be prevalent), as the fragment is being sent in manageable pieces.

In operation of another example flow, along with the common format data itself, ODE takes metadata as an input in the translation process. If the common format metadata included a prediction of the target format segment size, then this number can be included in the HTTP response. This would allow the ODE server to begin sending data before the entire target format segment is available.

The common format metadata can be generated by the same ABR video pipeline element that produces the common format data (i.e., the common format publisher). The common format publisher can generate indexing information such that the ODE server can easily access a particular common format segment when a target format segment is requested. In order to generate this indexing, the common format publisher should inspect the common format data. For example, if the common format is ATS, the common format publisher can inspect the common format data down to the MPEG2-PES level.

Given that the common format publisher is already performing a deep inspection of the common format data, it is reasonable to assume that the same process could also maintain a set of counters that would aide in predicting the size of a target format segment. For example, the common format publisher could maintain a total of the number of MPEG2-TS packets in a particular segment. The count could be further broken down by packet identifier (PID). At the same time, the common format publisher can maintain a count of the total amount of H.264 data in a particular segment, or the amount of Advanced Audio Coding (AAC) audio data. These metrics could then be included in the common format metadata.

Once included in the common format metadata, the counters could be used to predict the size of a target format segment before it is translated on the ODE server. For example, if the amount of H.264 data in a common format segment is known, it could be used to predict the size of the MDAT box for a Microsoft Smooth, or a DASH International Organization for Standardization (ISO)-base media file format (BMFF) (ISO-BMFF) target format. ISO base media file format defines a general structure for time-based multimedia files such as video and audio. It can be used as the basis for other media file formats (e.g., container formats MP4, 3GP, etc.). For Apple HTTP Live Streaming, simply knowing the number of MPEG2-TS packets on each PID in a common format segment can allow the ODE server to predict the size of the HLS segment. Size predictions need not be exact and may be padded in case of uncertainty. For example, both ISO-BMFF and MPEG2-TS can be padded by using extra boxes and null packets, respectively.

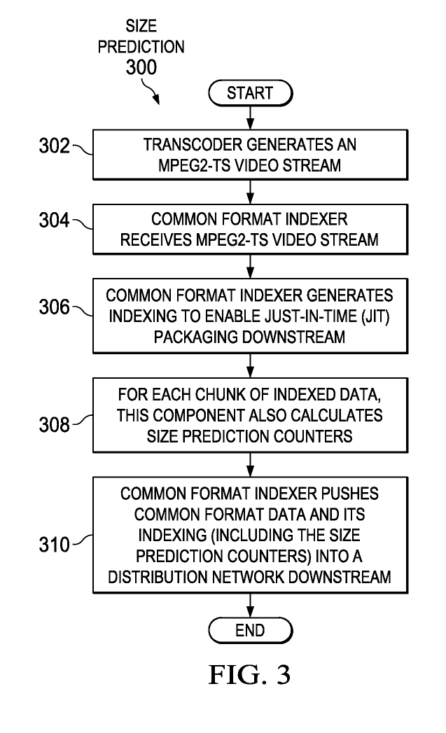

Turning to FIG. 3, FIG. 3 is a simplified flowchart 300 that can be used to help illustrate certain activities of the present disclosure. In one particular example, the system can be used for effectively size predicting any particular streaming flow. These example activities may begin at 302, where the transcoder can generate an MPEG2-TS video stream. The common format indexer receives the MPEG2-TS video stream (304) and generates indexing to enable just-in-time (JIT) packaging downstream (306). For each chunk of indexed data, this component also calculates size prediction counters, which can include (but which are not limited to): a number of TS packets per elementary stream; bytes of raw data per elementary stream; number of video frames are audio access units per elementary stream, etc. At 310, the common format indexer pushes common format data and its indexing (including the size prediction counters) into a distribution network downstream.

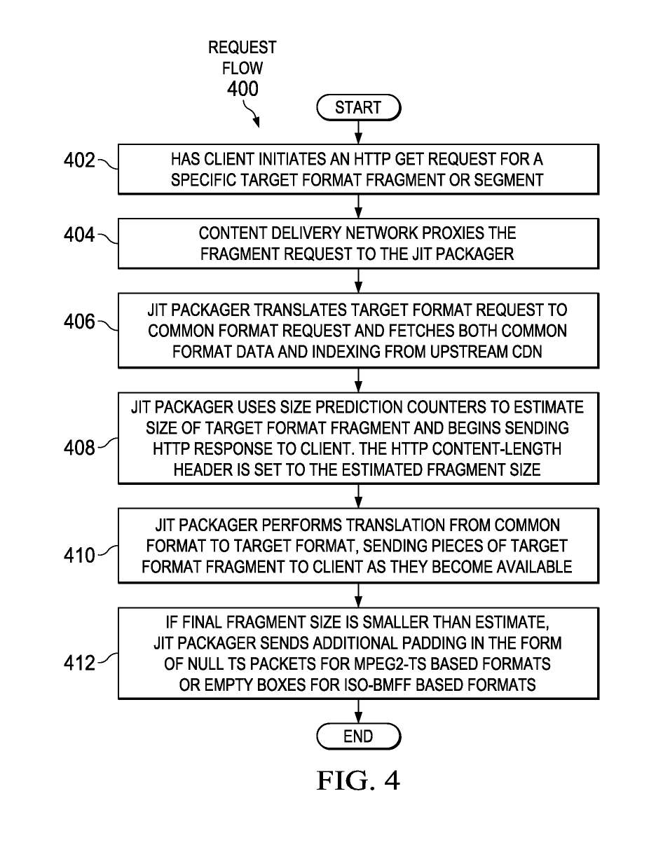

Turning to FIG. 4, FIG. 4 is a simplified flowchart 400 that can be used to help illustrate certain activities of the present disclosure. This particular flow may begin at 402, where a client initiates an HTTP GET request for a specific target format fragment (or segment). The CDN can proxy the fragment request to the JIT packager at 404. At 406, the JIT packager translates a target format request to a common format request and, further, fetches both common format data and indexing from the upstream CDN. At 408, the JIT packager uses size prediction counters to estimate the size of a target format fragment. It also begins sending the HTTP response to the client. The HTTP content length header can also be set to the estimated fragment size. At 410, the JIT packager can perform a translation from a common format to a target format, sending pieces of the target format fragment to the client, as they become available. If the final fragment sizes smaller than the estimate, the JIT packager can send additional padding in the form of null TS packets for MPEG2-TS based formats, or empty boxes for ISO-BMFF based formats.

Referring briefly back to certain internal structure that could be used to accomplish the teachings of present disclosure, HAS clients 18a-c can be associated with devices, customers, or end users wishing to receive data or content in communication system 10 via some network. The term HAS client′ and ‘client device’ is inclusive of any devices used to initiate a communication, such as any type of receiver, a computer, a set-top box, an Internet radio device (IRD), a cell phone, a smartphone, a laptop, a tablet, a personal digital assistant (PDA), a Google Android™, an iPhone™, an iPad™, a Microsoft Surface™, or any other device, component, element, endpoint, or object capable of initiating voice, audio, video, media, or data exchanges within communication system 10. HAS clients 18a-c may also be inclusive of a suitable interface to the human user, such as a display, a keyboard, a touchpad, a remote control, or any other terminal equipment. HAS clients 18a-c may also be any device that seeks to initiate a communication on behalf of another entity or element, such as a program, a database, or any other component, device, element, or object capable of initiating an exchange within communication system 10. Data, as used herein in this document, refers to any type of numeric, voice, video, media, audio, or script data, or any type of source or object code, or any other suitable information in any appropriate format that may be communicated from one point to another.

Transcoder 17 (or a multi-bitrate encoder) is a network element configured for performing one or more encoding operations. For example, transcoder 17 can be configured to perform direct digital-to-digital data conversion of one encoding to another (e.g., such as for movie data files or audio files). This is typically done in cases where a target device (or workflow) does not support the format, or has a limited storage capacity that requires a reduced file size. In other cases, transcoder 17 is configured to convert incompatible or obsolete data to a better-supported or more modern format.

Network 16 represents a series of points or nodes of interconnected communication paths for receiving and transmitting packets of information that propagate through communication system 10. Network 16 offers a communicative interface between sources and/or hosts, and may be any local area network (LAN), wireless local area network (WLAN), metropolitan area network (MAN), Intranet, Extranet, WAN, virtual private network (VPN), or any other appropriate architecture or system that facilitates communications in a network environment. A network can comprise any number of hardware or software elements coupled to (and in communication with) each other through a communications medium.

In one particular instance, the architecture of the present disclosure can be associated with a service provider digital subscriber line (DSL) deployment. In other examples, the architecture of the present disclosure would be equally applicable to other communication environments, such as an enterprise wide area network (WAN) deployment, cable scenarios, broadband generally, fixed wireless instances, fiber-to-the-x (FTTx), which is a generic term for any broadband network architecture that uses optical fiber in last-mile architectures, and data over cable service interface specification (DOCSIS) cable television (CATV). The architecture can also operate in junction with any 3G/4G/LTE cellular wireless and WiFi/WiMAX environments. The architecture of the present disclosure may include a configuration capable of transmission control protocol/internet protocol (TCP/IP) communications for the transmission and/or reception of packets in a network.

In more general terms, origin server 45, common format indexer 50, and servers 12a-b are network elements that can facilitate the size estimation activities discussed herein. As used herein in this Specification, the term ‘network element’ is meant to encompass any of the aforementioned elements, as well as routers, switches, cable boxes, gateways, bridges, loadbalancers, firewalls, inline service nodes, proxies, servers, processors, modules, or any other suitable device, component, element, proprietary appliance, or object operable to exchange information in a network environment. These network elements may include any suitable hardware, software, components, modules, interfaces, or objects that facilitate the operations thereof. This may be inclusive of appropriate algorithms and communication protocols that allow for the effective exchange of data or information.

In one implementation, origin server 45, common format indexer 50, and/or servers 12a-b include software to achieve (or to foster) the size estimation activities discussed herein. This could include the implementation of instances of size prediction modules 60, indexing module 65, and/or any other suitable element that would foster the activities discussed herein. Additionally, each of these elements can have an internal structure (e.g., a processor, a memory element, etc.) to facilitate some of the operations described herein. In other embodiments, these size estimation activities may be executed externally to these elements, or included in some other network element to achieve the intended functionality. Alternatively, origin server 45, common format indexer 50, and/or servers 12a-b may include software (or reciprocating software) that can coordinate with other network elements in order to achieve the size estimation activities described herein. In still other embodiments, one or several devices may include any suitable algorithms, hardware, software, components, modules, interfaces, or objects that facilitate the operations thereof.

In certain alternative embodiments, the size estimation techniques of the present disclosure can be incorporated into a proxy server, web proxy, cache, CDN, etc. This could involve, for example, instances of size prediction modules 60, indexing module 65, etc. being provisioned in these elements. Alternatively, simple messaging or signaling can be exchanged between an HAS client and these elements in order to carry out the activities discussed herein.

In operation, a CDN can provide bandwidth-efficient delivery of content to HAS clients 18a-c or other endpoints, including set-top boxes, personal computers, game consoles, smartphones, tablet devices, iPads™, iPhones™, Google Droids™, Microsoft Surfaces™, customer premises equipment, or any other suitable endpoint. Note that servers 12a-b (previously identified in FIG. 1A) may also be integrated with or coupled to an edge cache, gateway, CDN, or any other network element. In certain embodiments, servers 12a-b may be integrated with customer premises equipment (CPE), such as a residential gateway (RG).

As identified previously, a network element can include software (e.g., size prediction modules 60, indexing module 65, etc.) to achieve the size estimation operations, as outlined herein in this document. In certain example implementations, the size estimation functions outlined herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by a processor [processors shown in FIG. 2], or other similar machine, etc.). In some of these instances, a memory element [memories shown in FIG. 2] can store data used for the operations described herein. This includes the memory element being able to store instructions (e.g., software, code, etc.) that are executed to carry out the activities described in this Specification. The processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving the size estimation activities, as outlined herein. Additionally, each of these devices may include a processor that can execute software or an algorithm to perform the size estimation activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that while the preceding descriptions have addressed certain ABR management techniques, it is imperative to note that the present disclosure can be applicable to other protocols and technologies (e.g., Microsoft Smooth′ Streaming (HSS™), Apple HTTP Live Streaming (HLS™), Adobe Zeri™ (HDS), Silverlight™, etc.). In addition, yet another example application that could be used in conjunction with the present disclosure is Dynamic Adaptive Streaming over HTTP (DASH), which is a multimedia streaming technology that could readily benefit from the techniques of the present disclosure. DASH is an adaptive streaming technology, where a multimedia file is partitioned into one or more segments and delivered to a client using HTTP. A media presentation description (MPD) can be used to describe segment information (e.g., timing, URL, media characteristics such as video resolution and bitrates). Segments can contain any media data and could be rather large. DASH is codec agnostic. One or more representations (i.e., versions at different resolutions or bitrates) of multimedia files are typically available, and selection can be made based on network conditions, device capabilities, and user preferences to effectively enable adaptive streaming. In these cases, communication system 10 could perform appropriate size estimation based on the individual needs of clients, servers, etc.

Additionally, it should be noted that with the examples provided above, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 10 (and its techniques) are readily scalable and, further, can accommodate a large number of components, as well as more complicated/sophisticated arrangements and configurations. Accordingly, the examples provided should not limit the scope or inhibit the broad techniques of communication system 10, as potentially applied to a myriad of other architectures.

It is also important to note that the steps in the preceding FIGURES illustrate only some of the possible scenarios that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

It should also be noted that many of the previous discussions may imply a single client-server relationship. In reality, there is a multitude of servers in the delivery tier in certain implementations of the present disclosure. Moreover, the present disclosure can readily be extended to apply to intervening servers further upstream in the architecture, though this is not necessarily correlated to the ‘m’ clients that are passing through the ‘n’ servers. Any such permutations, scaling, and configurations are clearly within the broad scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving a request for video content from a client device;
accessing a common format representation for a requested chunk within the video content, wherein the common format representation is provided in one or more files that include metadata indicative of one or more counters;
using the common format representation in conjunction with a deterministic equation to identify a predicted size of an output to be sent to the client device; and
using the predicted size of the output to initiate transmitting at least a portion of a response to the client.

2. The method of claim 1, further comprising:
adding buffering as part of the response to pad at least some packets being provided to the client device.

3. The method of claim 2, wherein the buffering includes one or more null transport stream (TS) packets for moving picture experts group (MPEG)-TS based formats.

4. The method of claim 2, wherein the buffering includes one or more empty boxes associated with an International Organization for Standardization (ISO)-base media file format (BMFF) (ISO-BMFF).

5. The method of claim 1, wherein the accessing includes identifying common format indexing and common format data for the requested chunk.

6. The method of claim 5, wherein the common format indexing includes metadata that includes the one or more counters that can be read by a packager module configured to translate a target format request to a common format request, and to fetch the common format data and the common format indexing data from a content delivery network (CDN).

7. The method of claim 1, wherein the one or more counters include a number of TS packets per packet identifier (PID) within the common format.

8. The method of claim 1, wherein the one or more counters include an amount of data in bytes of raw video.

9. The method of claim 1, wherein the one or more counters include an amount of data in bytes of audio video.

10. The method of claim 1, wherein the one or more counters include an amount of raw data per PID.

11. The method of claim 1, further comprising:
setting one or more content length headers based on the predicted size of the output.

12. The method of claim 1, further comprising:
setting a buffer based on the predicted size of the output.

13. The method of claim 1, further comprising:
reading particular video data associated with the requested chunk from a disk;
translating the particular video data into a format associated with the client device; and
transmitting at least a portion of the response to the client device.

14. One or more non-transitory tangible media that includes code for execution and when executed by a processor operable to perform operations comprising:
receiving a request for video content from a client device;
accessing a common format representation for a requested chunk within the video content, wherein the common format representation is provided in one or more files that include metadata indicative of one or more counters;
using the common format representation in conjunction with a deterministic equation to identify a predicted size of an output to be sent to the client device; and
using the predicted size of the output to initiate transmitting at least a portion of a response to the client.

15. The non-transitory tangible media of claim 14, the operations further comprising:
adding buffering as part of the response to pad at least some packets being provided to the client device.

16. The non-transitory tangible media of claim 14, the operations further comprising:
setting one or more content length headers based on the predicted size of the output.

17. A network element, comprising:
a processor;
a memory; and
a size prediction module, wherein the network element is configured to:
receive a request for video content from a client device;
access a common format representation for a requested chunk within the video content, wherein the common format representation is provided in one or more files that include metadata indicative of one or more counters;
use the common format representation in conjunction with a deterministic equation to identify a predicted size of an output to be sent to the client device; and
use the predicted size of the output to initiate transmitting at least a portion of a response to the client.

18. The network element of claim 17, wherein the network element is further configured to:
add buffering as part of the response to pad at least some packets being provided to the client device.

19. The network element of claim 17, wherein the network element is further configured to:
set one or more content length headers based on the predicted size of the output.

20. The network element of claim 17, further comprising:
a packager module configured to:
read the one or more counters;
translate a target format request to a common format request; and
fetch common format data and common format indexing data from a content delivery network (CDN).
